(19) United States
(12) Patent Application Publication
(10) Pub. No.: US 2006/0007699 A1
(43) Pub. Date: Jan. 12, 2006

(54) Decorative application with optical fiber light guiding assembly

(76) Inventor: I-Ying Hwang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/883,855

(22) Filed: Jul. 6, 2004

(51) Int. Cl. F21V 7/04

(52) U.S. Cl. 362/551

(57) ABSTRACT

A decorative application with an optical fiber light guiding assembly includes an article to be decorated, a light-conducting plate associated with the article, and at least one optical fiber coupled with and extended from a light-emitting module. The optical fiber has a light source lead-out that is extended to an opening provided on the article to face toward the light-conducting plate fitted in the opening. Light emitted from the light-emitting module is guided by the at least one optical fiber to the light source lead-out, from where the light is projected toward the light-conducting plate to produce an illuminated decorating effect.

### BACKGROUND OF THE INVENTION

1. Field of the Invention

The present invention relates to an illuminating decorative application, and more particularly to a decorative application with optical fiber light guiding assembly.

Most conventional books, diaries, and other types of bound publications include a front cover, a back cover, and a plurality of leaves between the front and back covers. The front cover, the leaves, and the back cover are sequentially bound together at one side using adhesive, rings, or the like, so that the front and back covers and the leaves may be turned about the bound side. To provide various kinds of books with a visually beautiful appearance, an illuminating decoration has been developed to decorate books. FIG. 1 is a perspective view of a book 1 with a conventional decorative application with optical fiber light guiding assembly. The book 1, which may be otherwise a diary or any other bound publication, has a rigid cover 11 provided with a lighting area 12, within which a plurality of holes 13 are provided. A light-emitting module 14 and a battery 15 are arranged in the rigid cover 11 at a predetermined position, and a plurality of optical fibers 16 are connected at a proximal end to the light-emitting module 14, and a distal end 161 to one of the holes 13 on the rigid cover 11 of the book 1. In this manner, light emitted from the light-emitting module 14 is guided by the optical fibers 16 to the distal ends 161 to illuminate the rigid cover 11.

Most of the currently available decorative applications with optical fibers as light guiding means have the above-described structure. U.S. Pat. No. 6,234,657 discloses a decorative article associated with optical fibers for guide light.

With the above-mentioned conventional optical fiber light guiding assembly, the distal ends of the optical fibers produce only light spots on the rigid cover of the book to create very limited decorating effect. Moreover, the optical fibers must be arranged with the distal ends perpendicular to the holes. This arrangement inevitably increases an overall thickness of the rigid cover of the book to possibly spoil an overall visual beauty of the book.

### SUMMARY OF THE INVENTION

A primary object of the present invention is to provide a decorative application with optical fiber light guiding assembly to eliminate the drawbacks existed in the conventional similar designs.

To achieve the above object, the present invention includes a light-conducting plate fitted in an opening provided on an article to be decorated. Light emitted from a light-emitting module is guided by optical fibers to project toward the light-conducting plate to produce illuminated decorating effect.

Another object of the present invention is to provide a decorative application with optical fiber light guiding assembly that provides enhanced illuminating and decorating effect superior to the simple effect created only by light spots.

A further object of the present invention is to provide a decorative application with optical fiber light guiding assembly that has a relatively small overall thickness resulted from improved arrangements of optical fibers in an article to be decorated.

The present invention is superior to the conventional designs in that it enables the light emitted from the light-emitting module to be guided by the optical fibers to project toward the light-conducting plate and evenly create an illuminated decorating effect over a wide surface instead of only some spots. The reduced overall thickness of the present invention also makes it more practical for use in commercial applications.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a conventional decorative application with optical fiber light guiding assembly;

FIG. 2 is a perspective view of a decorative application with optical fiber light guiding assembly according to a first embodiment of the present invention;

FIG. 3 is a perspective view showing arrangements of different components of the decorative application with optical fiber light guiding assembly of FIG. 2;

FIG. 4 is a sectional view taken along line 4-4 of FIG. 2;

FIG. 5 is a sectional view showing the present invention is implemented on a flexible article made of a soft material;

FIG. 6 is a perspective view of a decorative application with optical fiber light guiding assembly according to a second embodiment of the present invention;

FIG. 7 shows the arrangement of optical fibers in the second embodiment of the present invention as shown in FIG. 6; and

FIG. 8 is a perspective view of a decorative application with optical fiber light guiding assembly according to a third embodiment of the present invention.

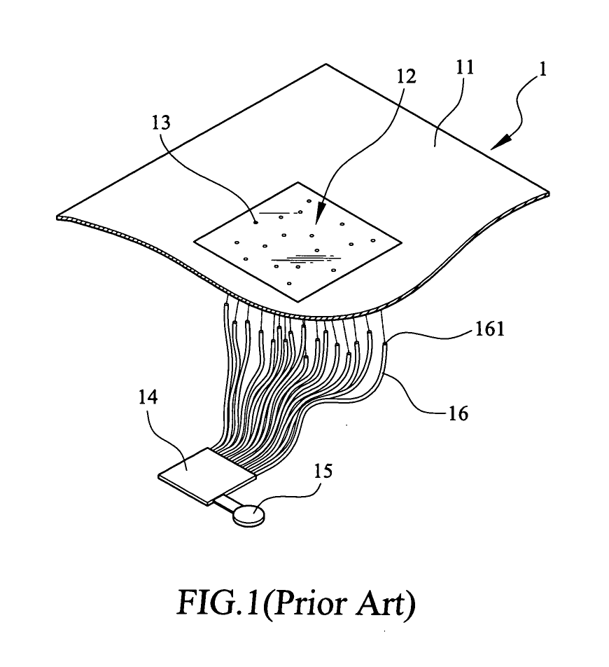

### DETAILED DESCRIPTION OF THE PREFERRED EMBODIMENTS

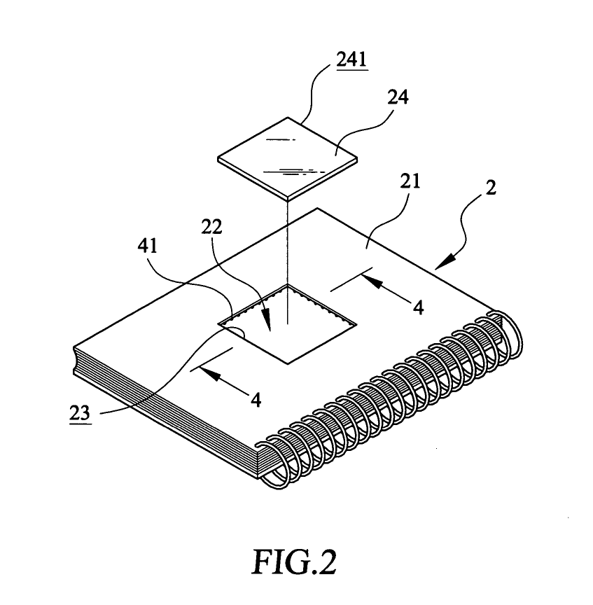

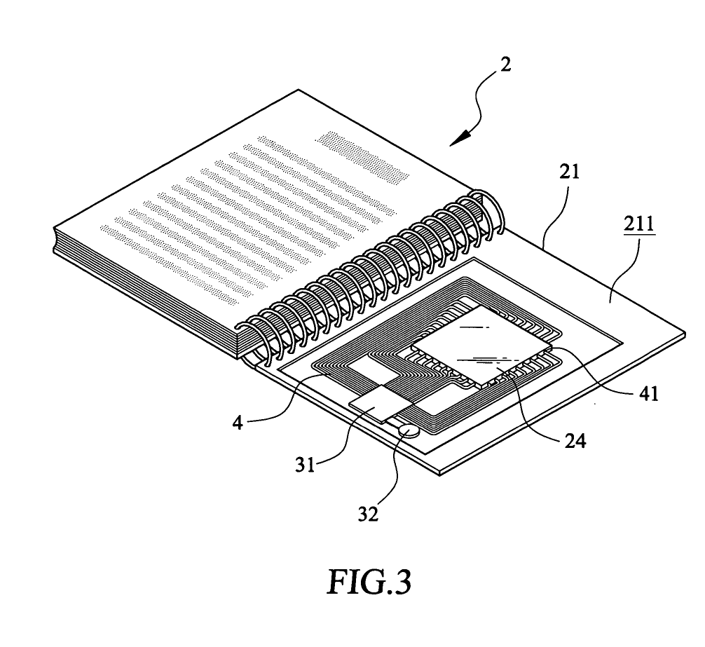

Please refer to FIGS. 2 and 3 that are front and reverse sides, respectively, of a cover of a book on which a decorative application with optical fiber light guiding assembly according to a first embodiment of the present invention is implemented. As shown, the present invention is implemented on an article to be decorated, such as a book 2 illustrated in FIG. 2, and includes a light-conducting plate 24 made of a light-pervious material or a translucent material and having different patterns and colors formed thereon, a light-emitting module 31 having a plurality of optical fibers 4 coupled therewith, and a battery 32 for powering the light-emitting module 31 to emit light.

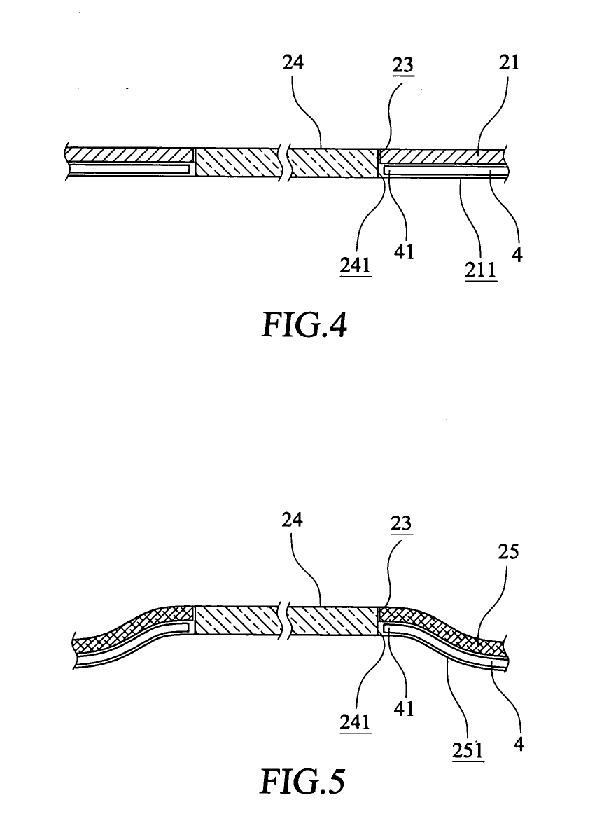

The book 2 includes a rigid cover 21 having a portion being cut away to provide an opening 22 having inner edges 23. An inner or reverse side 211 of the rigid cover 21 is provided with a flat recess, in which the light-emitting module 31, the battery 32, and the optical fibers 4 are arranged. The light-conducting plate 24 has area and shape corresponding to that of the opening 22 on the rigid cover 21 of the book 2 to be fitly received in the opening 22. The optical fibers 4 coupled with and extended from the light-emitting module 31 have light source lead-outs 41 parallelly arranged along the inner edges 23 of the opening 22. In the first embodiment of the present invention, the light source lead-outs 41 are distal ends of the optical fibers 4 and arranged in perpendicular to outer edges 241 of the light-conducting plate 24 fitted in the opening 22 on the rigid cover 21 of the book 2, as shown in FIG. 4.

Light emitted from the light-emitting module 31 is guided by the optical fibers 4 coupled with and extended from the module 31 to the light source lead-outs 41, from where the light is projected toward the light-conducting plate 24 and produces an illuminated decorative effect.

Please refer to FIG. 5. The article to be decorated with the present invention is not limited to a book with rigid cover. The present invention may also be implemented on other types of articles, such as a flexible article 25 made of a soft material, including, for example, a piece of fabric, a fabric knapsack, etc., with an opening formed thereon for receiving a light-conducting plate.

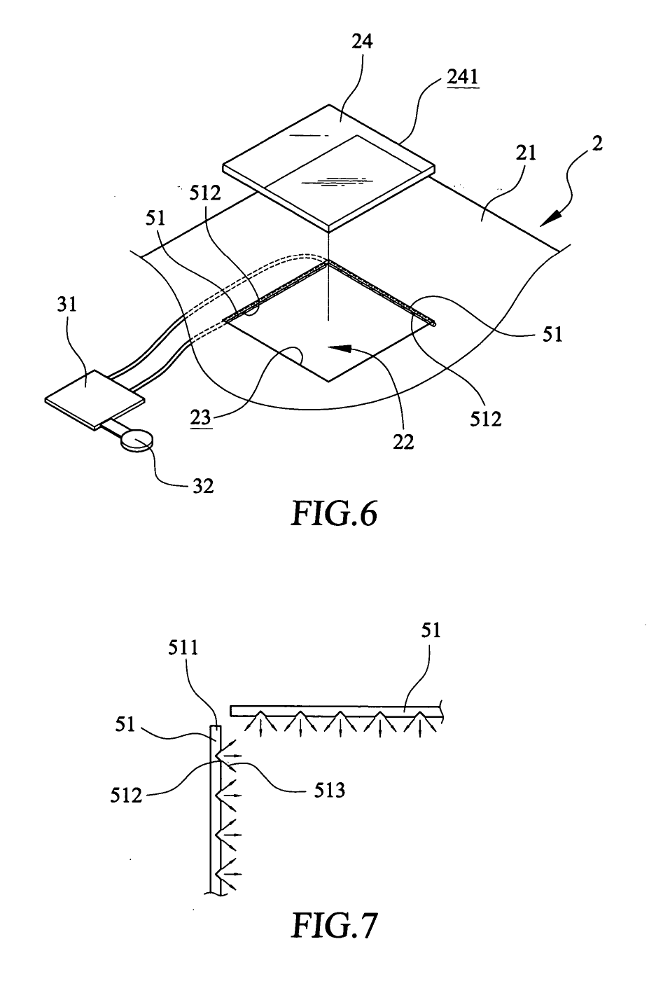

FIG. 6 is a perspective view showing a second embodiment of the present invention. The second embodiment is generally similar to the first embodiment in the design, and components similar in these two embodiments are denoted with the same reference numeral.

In the illustrated second embodiment, the article to be decorated with the present invention is still a book 2 having a rigid cover 21 with an opening 22. The opening 22 has inner edges 23 and is adapted to fitly receive a light-conducting plate 24 therein.

At least one optical fiber 51 coupled with and extended from a light-emitting module 31 is parallelly arranged along the inner edges 23 of the opening 22. A battery 32 supplies power needed by the light-emitting module 31 to emit light.

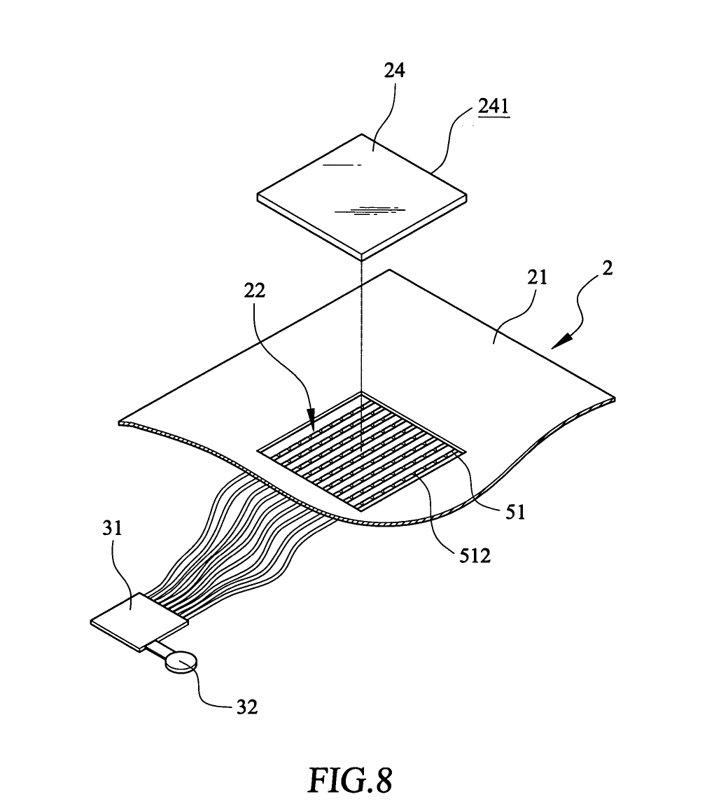

The optical fiber 51 has a distal end forming a light source lead-out 511, and is provided along one side with a plurality of spaced sideways light source lead-outs 512. Please refer to FIG. 7. When the light emitted from the light-emitting module 31 passes through the at least one optical fiber 51, part of the light source 513 is guided out at the sideways light source lead-outs 512 to project toward the light-conducting plate 24 and thereby produces an illuminated decorating effect.

The sideways light source lead-outs 512 are formed on the optical fiber 51 by, for example, forming at one side of the optical fiber 51 with notches having a predetermined opening angle, so that part of the light source 513 passing through the optical fiber 51 is guided out of the optical fiber 51 via the sideways light source lead-outs 512.

FIG. 8 is a perspective view showing a third embodiment of the present invention. In the third embodiment, there are provided a plurality of optical fibers 51 coupled with and extended from a light-emitting module 31, which is powered with a battery 32. The optical fibers 51 are parallelly arranged to extend through a lower side of the opening 22 provided on a rigid cover 21 of a book 2 to be decorated using the present invention. As in the second embodiment, the optical fibers in the third embodiment are also provided along one side with a plurality of spaced sideways light source lead-outs 512, so that these sideways light source lead-outs 512 are located within the opening 22 to face toward a lower side of the light-conducting plate 24 fitted in the opening 22.

Again, part of the light emitted from the light-emitting module 31 is projected via the sideways light source lead-outs 512 toward the light-conducting plate 24 to produce an illuminated decorated effect.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An optical fiber light guiding assembly for an article to be decorated, comprising:
a light-conducting plate with an outer edge, received in an opening with an inner edge formed on said article;
a light-emitting module set in said article for emitting a light source;
a battery electrically connected to said light-emitting module for supplying a power energy to said light-emitting module to produce said light source; and
at least one optical fiber coupled with and extended from said light-emitting module, said optical fiber having a light source lead-out, which is located adjacent to said inner edge of said opening on said article to thereby face toward outer edge of said light-conducting plate received in said opening;
whereby when said light-emitting module emits light, which is guided by said optical fiber coupled with and extended from said light-emitting module to said light source lead-out of each said optical fiber, and then projected toward said light-conducting plate.

2. The optical fiber light guiding assembly as claimed in claim 1, wherein said article to be decorated is a book, and said opening is provided on a rigid cover of said book.

3. The optical fiber light guiding assembly as claimed in claim 1, wherein said article to be decorated is a flexible member made of a soft material, and said opening is provided on said flexible member.

4. The optical fiber light guiding assembly as claimed in claim 1, wherein said light-source lead-out of each said optical fiber is a distal end of each said optical fiber and is arranged to perpendicularly face toward said outer edges of said light-conducting plate.

5. The optical fiber light guiding assembly as claimed in claim 1, wherein said optical fiber is parallelly arranged along said inner edge of said opening on said article to be decorated, and each of said optical fiber being provided along one side with a plurality of spaced sideways light source lead-outs, via which part of said light emitted from said light-emitting module is guided out to project toward said light-conducting plate.

6. The optical fiber light guiding assembly as claimed in claim 1, wherein said optical fiber is extended through a lower side of said opening on said article to be decorated, and provided with a plurality of spaced sideways light source lead-outs, said sideways light source lead-outs being located within said opening to face toward a lower side of said light-conducting plate, and part of said light emitting from said light-emitting module being guided out via said sideways light source lead-outs to project toward said light-conducting plate.
